(19) United States
(12) Patent Application Publication
(10) Pub. No.: US 2009/0103554 A1
(43) Pub. Date: Apr. 23, 2009

(54) DATA TRANSFER DEVICE FOR RING PROTOCOL HIGH SPEED SWITCHING AND METHOD FOR THE SAME

(76) Inventors: Shinichi Akahane, Hachioji (JP); Yasuhiro Kodama, Yokohama (JP); Tomohiko Kohno, Yokohama (JP); Tetsuya Nagata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/028,198

(22) Filed: Feb. 8, 2008

(30) Foreign Application Priority Data
Oct. 22, 2007 (JP) 2007-273770

(51) Int. Cl. H04L 12/56

(52) U.S. Cl. 370/406

(57) ABSTRACT

The present invention provides a data transfer device. This data transfer device comprises a number n (where n is an integer equal to 2 or greater) of transfer resources functioning as nodes of ring networks and connection lines connecting a number m (where m is an integer equal to 2 or greater) of ring networks and the number n of transfer resources. The connection lines are configured to be capable to connect at least some of the m ring networks and at least some of the n transfer resources. A controller controls transfer resource specified among at least some of the transfer resources to manage at least some of m number of ring networks.

### CROSS REFERENCE TO RELATED APPLICATIONS

This application relates to and claims priority from Japanese Patent Applications No. 2007-273770, filed on Oct. 22, 2007, the entire disclosure of which is incorporated by reference.

### BACKGROUND

1. Technical Field

The present invention relates to a technology for data transfer in a ring network.

2. Background of the Related Art

Ring networks enjoy widespread use due to their high reliability and smaller requirements for transmission path and interfaces. In a ring network configured with ring topology, failure in of even one data transfer device or transmission path will result in interrupted flow of data, so in the event of a failure on the network it is important to detect the failure and quickly switch the pathway.

One method for detecting failure of a data transfer device or transmission path making up a ring network involves having one of the data transfer devices periodically transmit control frames to the ring network and monitor transmission thereof. For example, according to the method taught in JP-A-2004-201009A, one of the devices on a ring network is designated as a monitoring device, with the other constituent devices being designated as relay devices. The monitoring device periodically transmits control frames from a port on one side, and monitors whether control frames relayed by the relay devices can be received by a port on the opposite side of the monitoring device. During the period that control frames are received by the port on the opposite side the ring network will be considered as operating normally; however, if a failure occurs on the network, control frames will no longer be received by the port on the opposite side, and it will therefore be possible to detect that failure has occurred. Meanwhile, demands for higher capacity, faster speeds, and higher reliability in networks have led to a need for switches able to manage large numbers of rings. It has proven difficult to maintain high-speed switching processes and to ensure scalability accommodating a larger numbers of rings in the network, while maintaining reliability.

### SUMMARY

The present invention is addressed to the above problem and has as an object to provide a technology for deployment in a ring network able to flexibly adapt to the need for higher switching process speeds and increased numbers of rings accommodated in a network.

An aspect of the present invention provides a data transfer device. This data transfer device comprises:

a number n(where n is an integer equal to 2 or greater) of transfer resources that function as nodes of a number m (where m is an integer equal to 2 or greater) of ring networks;

a number p (where p is an integer equal to 2 or greater) of ring management resources that manage at least some of the n transfer resources so as to function as master nodes of the ring networks;

connection lines that interconnect the p ring management resources and the n transfer resources; and

a controller portion that controls the ring management resources and the connection lines, and switches the ring management resources which manage at least some of the n transfer resources.

With the data transfer device, ring management resources that manage each of a plurality of transfer resources can be switched, whereby it will be possible to flexibly adapt to the need for faster process speeds or increased numbers of rings accommodated in the network, simply by increasing the number of transfer resources or ring management resources for example.

Furthermore, the load on the multiple ring management resources can be balanced easily through appropriate setting of the controller portion. Specifically, if load should temporarily become concentrated in a particular ring, management of other rings under management by the ring management resource which is managing the ring in question can be relegated to another ring management resource, for example.

The data transfer device is provided a plurality of frame processing portions having the transfer resources and the ring management resources. In this case, the controller portion may specify, in accordance with user input, any of the plurality of frame processing portions functioning as respective nodes for the m ring networks; and specify, in accordance with user input, a frame processing portion that will be switched to from the specified frame processing portion in the event that a failure occurs in the specified frame processing portion.

By so doing, operating conditions of data transfer devices when a failure has occurred on the network can be easily predicted (e.g. when making network settings) or analyzed (when a failure has occurred), thus reducing the burden of management.

In the data transfer device,

the frame processing portion may further include a destination determining portion for determining the transfer destination of the transfer resources; and

the destination determining portion may determine a destination such that a health-check frame received by the data transfer device is returned to the ring management resources within the data transfer device.

The data transfer device may be configured such that

at least some of the p ring management resources and the n transfer resources are interconnected by a crossbar switch; and

control of the connection lines includes switching of the crossbar switch; or as shown in a modification example (FIG. 27), a plurality of transfer resources and a plurality of frame transmitting/receiving portions FT1 through FTn are connectable in any combination.

The data transfer device may be configured such that the controller portion controls the ring management resources and the connection lines, and via the ring network under management by the ring management resources, returns to the ring management resource a health-check frame sent from the ring management resources.

The present invention further provides a data transfer method. One aspect of the data transfer method comprises the steps of providing a number n(where n is an integer equal to 2 or greater) of transfer resources functioning as nodes of a number m (where m is an integer equal to 2 or greater) of ring networks, a number p (where p is an integer equal to 2 or greater) of ring management resources for managing at least some of the n transfer resources so as to function as master nodes of the ring networks, and connection lines interconnecting the p ring management resources and the n transfer resources; and

controlling the ring management resources and the connection lines, and switching the ring management resources which manage at least some of the n transfer resources.

The present invention is not limited to the embodiments set forth above, and may also be reduced to practice as a data transfer control method. Various other embodiments would be possible as well, such as a computer program for building such a method or device; or a recording medium having such a computer program recorded thereon.

### BRIEF DESCRIPTION OF THE DRAWINGS

FIG. 1 is a block diagram depicting in overview a ring network system in an embodiment of the present invention;

FIG. 2 is an illustration depicting a first mode in which the ring R1 is managed by a first frame processing portion FP1;

FIG. 3 is an illustration depicting a second mode in which the ring R1 is managed by a second frame processing portion FP2;

FIG. 4 is an illustration depicting a third mode in which the ring R1 is managed by an n-th frame processing portion FP2;

FIG. 5 is an illustration depicting internal configuration of a number n of first through n-th destination determining portions HD1 through HDn in the embodiment;

FIG. 6 is an illustration showing the content of a VLAN determination table 112 of the embodiment;

FIG. 7 is an illustration showing the content of a VLAN group table 110 of the embodiment;

FIG. 8 is an illustration showing the content of a logic circuit status table 108 of the embodiment;

FIG. 9 is an illustration showing the content of a MAC address table 102 of the embodiment;

FIG. 10 is an illustration showing the content of a ring control frame monitoring table 103 of the embodiment;

FIG. 11 is an illustration depicting the internal configuration of a number n of first through n-th ring status management portions RS1 through RSn of the embodiment;

FIG. 12 is an illustration showing the content of a ring status table 203 of the embodiment;

FIG. 13 is an illustration showing the internal configuration of an n-th transfer processing portion DTn of the embodiment;

FIG. 14 is an illustration depicting control frame format of a ring control frame CF in the embodiment;

FIG. 15 is an illustration depicting device-internal control frame format of a device-internal control frame in the embodiment;

FIG. 16 is an illustration depicting data frame format of a data frame DF in the embodiment;

FIG. 17 is an illustration depicting device-internal data frame format of a device-internal data frame in the embodiment;

FIG. 18 is an illustration depicting frame format of a device-internal ring status management portion intercommunication frame in the embodiment;

FIG. 19 is a flowchart depicting the content of the process of Layer 2 ring protocol operation of the ring R1 in the embodiment of the present invention;

FIG. 20 is an illustration depicting Layer 2 ring protocol operation of the ring R1 in the embodiment;

FIG. 21 is an illustration depicting a state in which a failure has occurred on a circuit L23 in the ring R1;

FIG. 22 is a flowchart depicting the specifics of a rerouting process of the embodiment;

FIG. 23 is an illustration depicting rerouting in the event that a failure has occurred in the circuit L23 in the ring R1;

FIG. 24 is an illustration of a condition immediately after recovery by the circuit L23 in the ring R1;

FIG. 25 is a flowchart depicting the specifics of a path reconstitution process of the embodiment;

FIG. 26 is an illustration depicting transition of operation of the ring R1 to a normal condition; and

FIG. 27 is a block diagram depicting in overview a ring network system 100 in a modification example of the present invention.

### DETAILED DESCRIPTION OF THE PREFERRED EMBODIMENTS

A. Network Transfer System in an Embodiment of the Present Invention:

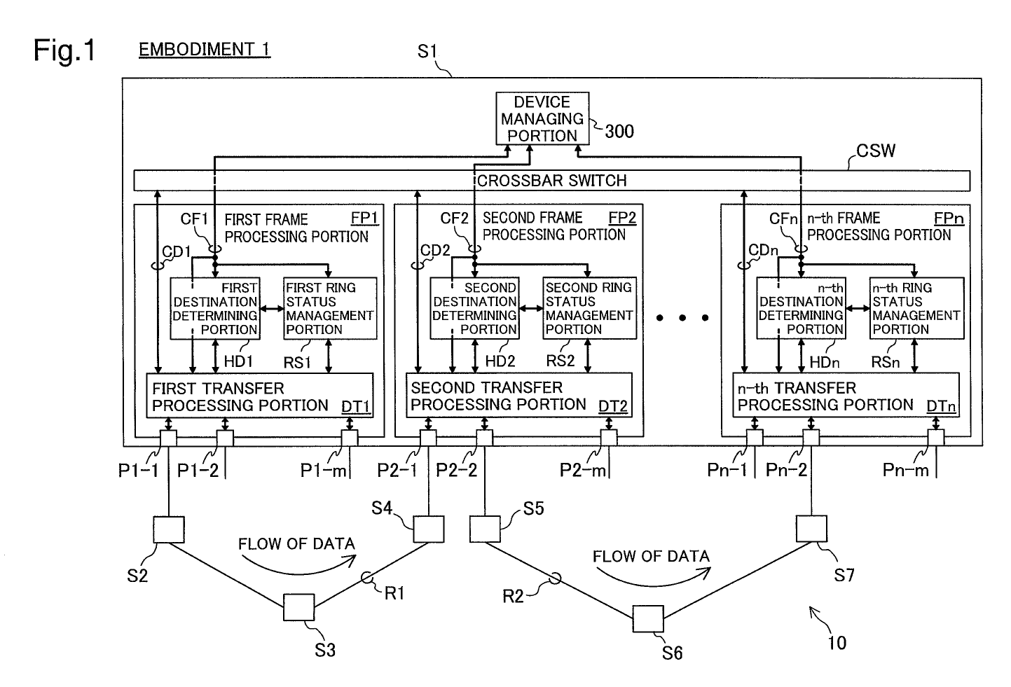

FIG. 1 is a block diagram depicting in overview a ring network system in an embodiment of the present invention. The ring network system of the present embodiment includes two rings R1, R2. The ring R1 and the ring R2 respectively include four switches S1 through S4, and four switches S1 and S5 through S7. The switch S1 has a number n of first through n-th frame processing portions FP1 through FPn; a crossbar switch CSW interconnecting these frame processing portions FP1 through FPn; and a device managing portion 300 for managing these components.

The first frame processing portion FP1 has a first destination determining portion HD1; a first ring status management portion RS1; a first transfer processing portion DT1; and a number m of input/output ports P1-1 through Pn-m. In the embodiment, the other frame processing portions FP2 through FPn each have a configuration identical to the first frame processing portion FP1.

Internal circuits CD1 through CDn connect the crossbar switch CSW with first through n-th transfer portions DT1 through DTn of the first through n-th frame processing portions FP1 through FPn. Frame data received, for example, by the input/output port P2-1 from the switch S4 will be transferred to the crossbar switch CSW via the internal circuit CD2. It is possible for this frame data to be transferred to any of the frame processing portions FP1 to FPn via the crossbar switch CSW controlled by the device managing portion 300, and any of the internal circuits CF1 to CFn.

The internal circuits CF1 through CFn interconnect the crossbar switch CSW with the destination determining portions HD1 through HFn, the ring status management portions RS1 through RSn, and the transfer processing portions DT1 through DTn of the first through n-th frame processing portions FP1 through FPn. The internal circuits CF1 through CFn are used for data transfer among the first through n-th frame processing portions FP1 through FPn via the crossbar switch CSW. The internal circuits CF1 through CFn also convey control instructions from the device managing portion 300 to the first through n-th frame processing portions FP1 through FPn via the crossbar switch CSW; and convey data indicating status of the first through n-th frame processing portions FP1 through FPn to the device managing portion 300.

This internal configuration of the switch S1 makes possible flexible use of the first through n-th frame processing portions FP1 through FPn as transfer resources. Specifically, transfer resources can manage the ring R1 as a master switch in the following three modes, for example. The individual first through n-th frame processing portions FP1 through FPn correspond to the “transfer resources” taught in the claims. The device managing portion 300 corresponds to the “controller portion” taught in the claims.

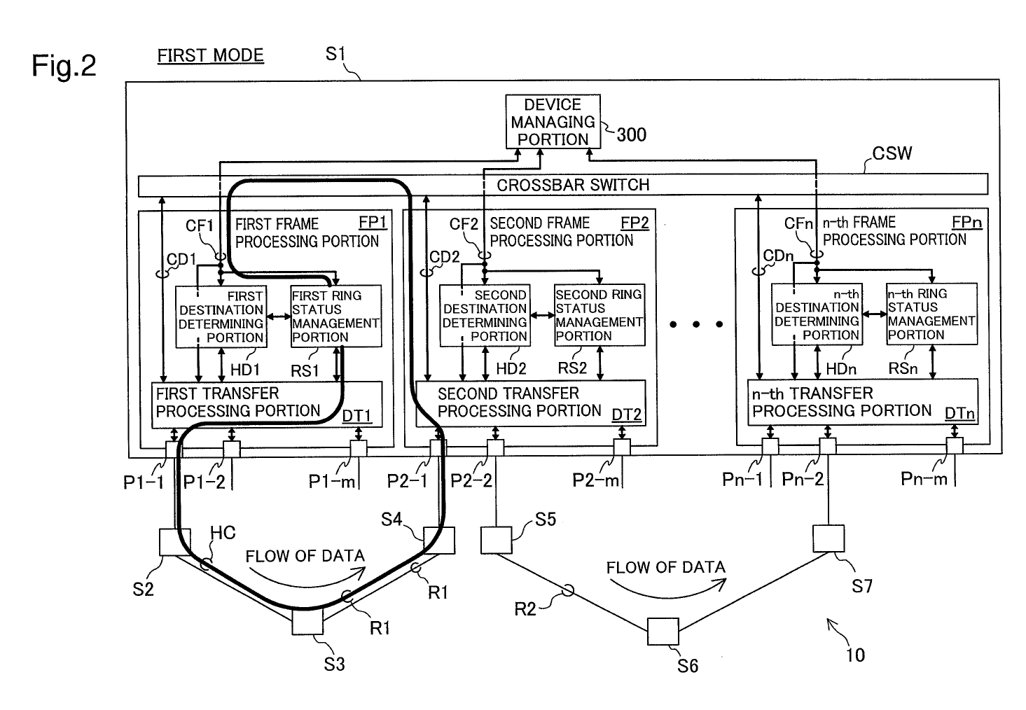

FIG. 2 is an illustration depicting a first mode in which the ring R1 is managed by the first frame processing portion FP1. In the first mode, it can be verified that no communication failure has occurred on the ring R1, through the following sequence for example.
(1) The first ring status management portion RS1 (the first frame processing portion FP1) will output a health-check frame HC to the input/output port P1-1 via the first transfer processing portion DT1.
(2) The health-check frame HC will be transmitted to the second transfer processing portion DT2 (the second frame processing portion FP2) via the three switches S2, S3, S4 and the input/output port P2-1.
(3) The second destination determining portion HD2 will analyze the header of the health-check frame HC that was transmitted to the second transfer processing portion DT2, and determine that the transfer destination of the health-check frame HC is the first ring status management portion RS1 (first frame processing portion FP1). On the basis of the result of this determination, the second destination determining portion HD2 will notify the second transfer processing portion DT2 that the first ring status management portion RS1 is the transfer destination.
(4) The second transfer processing portion DT2 will transmit the health-check frame HC to the first ring status management portion RS1 (the first frame processing portion FP1) via the internal circuit CD2 and the crossbar switch CSW.
(5) The first ring status management portion RS1 will confirm return of the health-check frame HC, and confirm that no communication failure has occurred on the ring R1.
(6) The second transfer processing portion DT2 will discard the health-check frame HC in response to this confirmation.

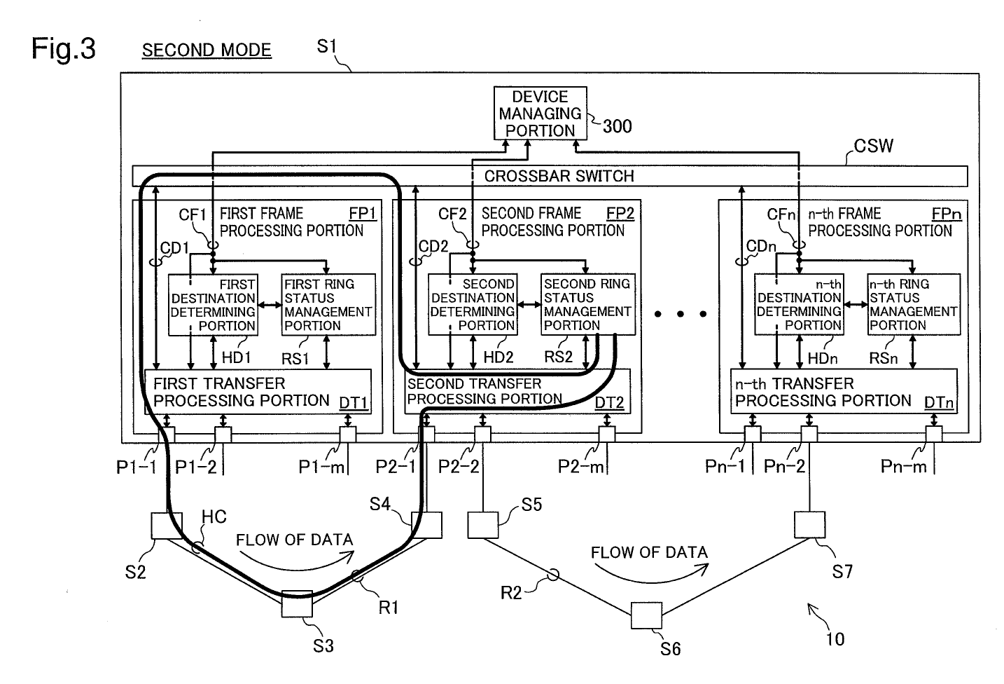

FIG. 3 is an illustration depicting a second mode in which ring R1 is managed by the second frame processing portion FP2. In the second mode, it can be verified that no communication failure has occurred on the ring R1, through the following sequence for example.
(1) The second ring status management portion RS2 will transmit a health-check frame HC to the second transfer processing portion DT2.
(2) The second destination determining portion HD2 will analyze the header of the health-check frame HC that was transmitted to the second transfer processing portion DT2, and determine that the transfer destination of the health-check frame HC is the first frame processing portion FP1. On the basis of the result of this determination, the second destination determining portion HD2 will notify the second transfer processing portion DT2 that the first transfer processing portion DT1 (the first frame processing portion FP1) is the transfer destination.
(3) The second transfer processing portion DT2 will transmit the health-check frame HC to the first transfer processing portion DT1 (the first frame processing portion FP1) via the internal circuit CD2 and the crossbar switch CSW.
(4) The first destination determining portion HD1 will analyze the header of the health-check frame HC that was transmitted to the first transfer processing portion DT1, and determine that the transfer destination of the health-check frame HC is the switch S2. On the basis of the result of this determination, the first destination determining portion HD1 will notify the first transfer processing portion DT1 that the switch S2 is the transfer destination.
(5) The first transfer processing portion DT1 will output the health-check frame HC to the input/output port P1-1 for transfer to the switch S2.
(6) The health-check frame HC will be further transmitted to the second transfer processing portion DT2 via the two switches S3, S4 and the input/output port P2-1.
(7) The second transfer processing portion DT2 will transmit the health-check frame HC to the second ring status management portion RS2.
(8) The second ring status management portion RS2 will confirm return of the health-check frame HC, and confirm that no communication failure has occurred on the ring R1.
(9) The second transfer processing portion DT2 will discard the health-check frame HC in response to this confirmation.

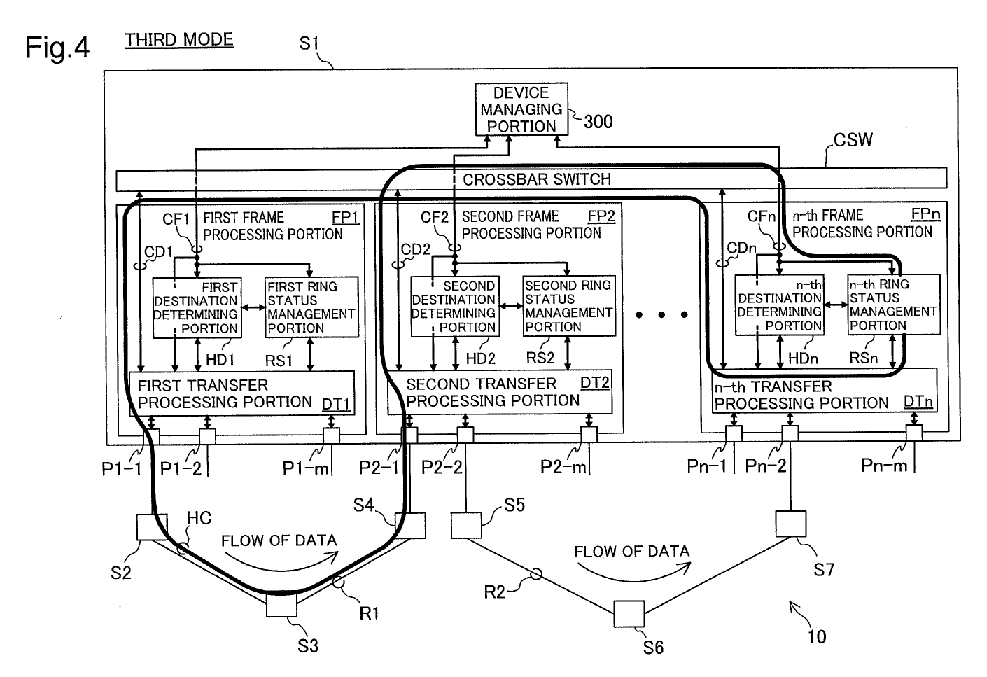

FIG. 4 is an illustration depicting a third mode in which the ring R1 is managed by the n-th frame processing portion. In the third mode, it can be verified that no communication failure has occurred on the ring R1, through the following sequence for example.
(1) The n-th ring status management portion RSn (the n-th frame processing portion FPn) will transmit a health-check frame HC to the n-th transfer processing portion DTn.
(2) The n-th destination determining portion HDn will analyze the header of the health-check frame HC that was transmitted to the n-th transfer processing portion DTn, and determine that the transfer destination of the health-check frame HC is the first frame processing portion FP1. On the basis of the result of this determination, the n-th destination determining portion HDn will notify the n-th transfer processing portion DTn that the first transfer processing portion DT1 (the first frame processing portion FP1) is the transfer destination.
(3) The n-th transfer processing portion DTn will transmit the health-check frame HC to the first transfer processing portion DT1 (the first frame processing portion FP1) via the internal circuit CDn and the crossbar switch CSW.
(4) The first destination determining portion HD1 will analyze the header of the health-check frame HC that was transmitted to the first transfer processing portion DT1, and determine that the transfer destination of the health-check frame HC is the switch S2. On the basis of the result of this determination, the first destination determining portion HD1 will notify the first transfer processing portion DT1 that the switch S2 is the transfer destination.
(5) The first transfer processing portion DT1 will output the health-check frame HC to the input/output port P1-1 for transfer to the switch S2.
(6) The health-check frame HC will be further transmitted to the second transfer processing portion DT2 via the two switches S3, S4 and the input/output port P2-1.
(7) The second destination determining portion HD2 will analyze the header of the health-check frame HC that was transmitted to the second transfer processing portion DT2, and determine that the transfer destination of the health-check frame HC is the n-th frame processing portion FPn. On the basis of the result of this determination, the second destination determining portion HD2 will notify the second transfer processing portion DT2 that the n-th transfer processing portion DTn (the n-th frame processing portion FPn) is the transfer destination.
(8) The second transfer processing portion DT2 will transmit the health-check frame HC to the n-th transfer processing portion DTn (the n-th frame processing portion FPn via the internal circuit CD2 and the crossbar switch CSW.
(9) The n-th ring status management portion RSn will confirm return of the health-check frame HC, and confirm that no communication failure has occurred on the ring R1.
(10) The second transfer processing portion DT2 will discard the health-check frame HC in response to this confirmation.

As will be understood from the first through third modes described above, management of the ring R1 which is connected via the first frame processing portion FP1 and the second frame processing portion FP2 is possible by any of the frame processing portions provided to the switch S1. The same is true of a ring connected to mutually different input/output ports of a given frame processing portion. However, connection to mutually different frames is preferable in terms of distributing the load among the frame processing portions.

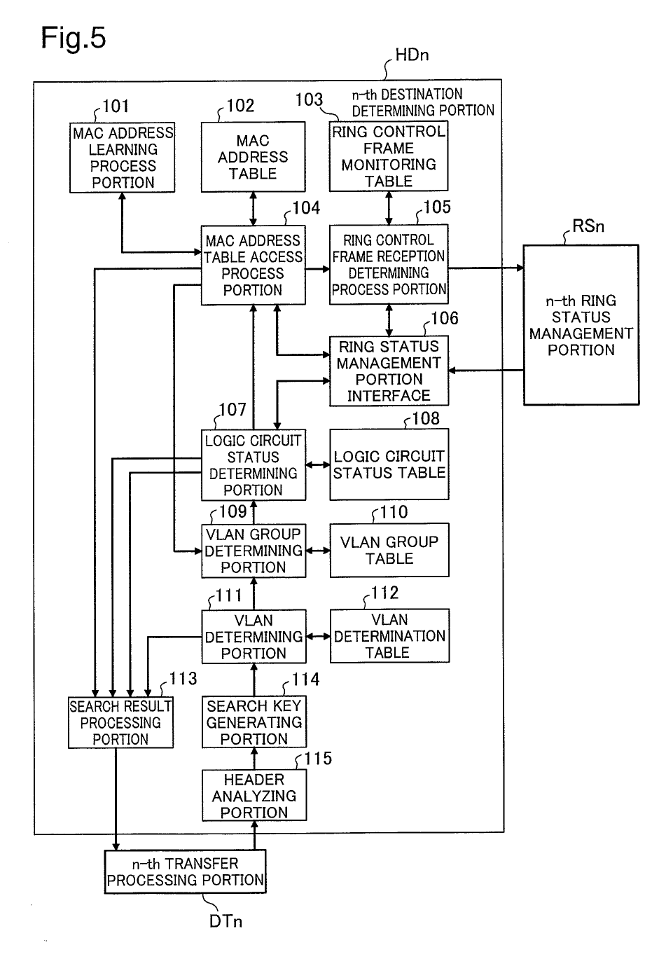

FIG. 5 is an illustration depicting the internal configuration of the n-th member of the n destination determining portions HD1 through HDn in the embodiment. The first through n-th members of the n destination determining portions HD1 through HDn have identical internal configuration. The n-th destination determining portion HDn includes a MAC address learning process portion 101; a MAC address table 102; a ring control frame monitoring table 103; a MAC address table access process portion 104; a ring control frame reception determining process portion 105; a ring status management portion interface 106; a logic circuit status determining portion 107; a logic circuit status table 108; a VLAN group determining portion 109; a VLAN group table 110; a VLAN determining portion 111; a VLAN determination table 112; a search result processing portion 113; a search key generating portion 114; and a header analyzing portion 115.

The n-th destination determining portion HDn executes the following process in response to reception of frame data from the n-th transfer processing portion DTn. In the present embodiment, the header analyzing portion 115 extracts the destination MAC address and the sender's MAC address from the header information contained in the frame data received from the first transfer processing portion DTn and transmits it, together with the port number of the input port and a VLAN tag (VLAN ID, etc.), to the search key generating portion 114. The search key generating portion 114 will then transmit generated search keys (discussed later) to the VLAN determining portion 111, the logic circuit status determining portion 107, and the MAC address table access process portion 104.

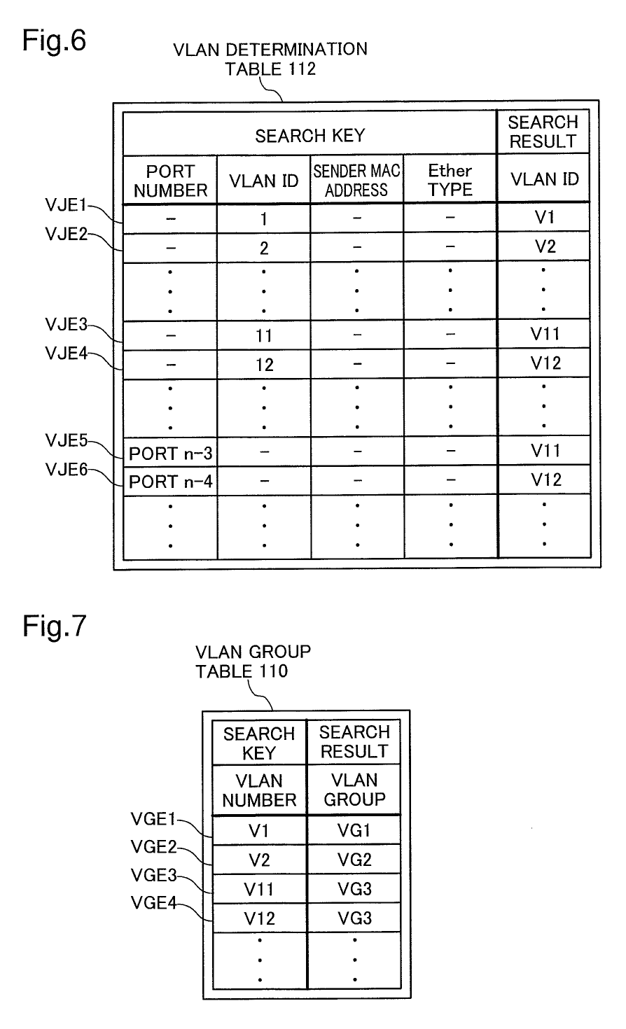

On the basis of the VLAN determination table 112 (FIG. 6), the VLAN determining portion 111 will decide on a VLAN number with reference to the search keys, i.e. the port number and VLAN ID. The VLAN number decided thusly will be handed over to the VLAN group determining portion 109.

On the basis of the VLAN group table 110 (FIG. 7), the VLAN group determining portion 109 will decide on a VLAN group with reference to the VLAN number. The VLAN group decided thusly will be handed over to the logic circuit status determining portion 107.

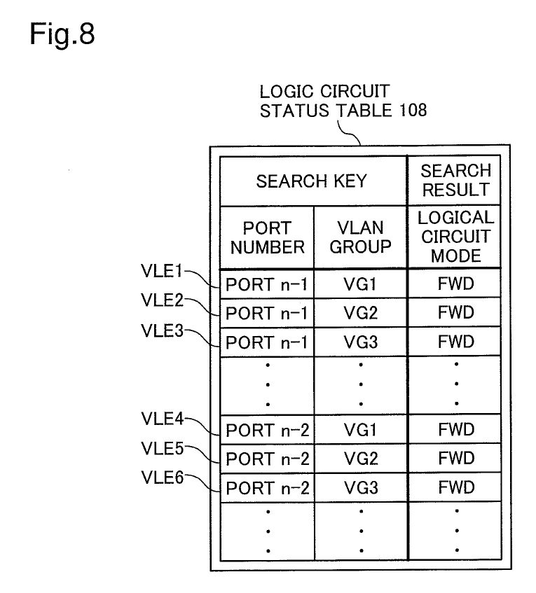

On the basis of the logic circuit status table 108 (FIG. 8), the logic circuit status determining portion 107 will determine the logic circuit status with reference to the search keys, i.e. the port number and VLAN ID. In the embodiment, logic circuit status includes settings for a forwarding mode FWD enabling data transfer over the circuit, and for a blocking mode BLK disabling data transfer over the circuit.

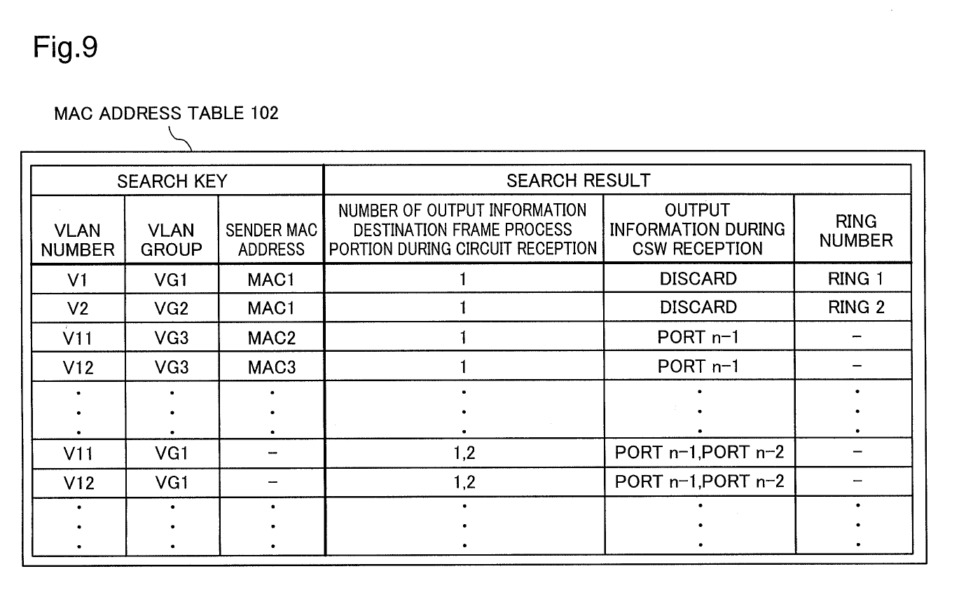

On the basis of the MAC address table 102 (FIG. 9), the MAC address table access process portion 104 will decide on process content for frame data when it is received, with reference to the search keys VLAN number, VLAN group, or sender's MAC address. Process content such as the following could be selected, for example.
(1) When data is received by any of the input/output ports P1-1 through Pn-m, whether to transfer it to any of the first through n-th frame processing portions FP1 through FPn.
(2) When data is received by any of the crossbar switches CSW, whether to transfer it to any of the input/output ports P1-1 through Pn-m, or discard it.

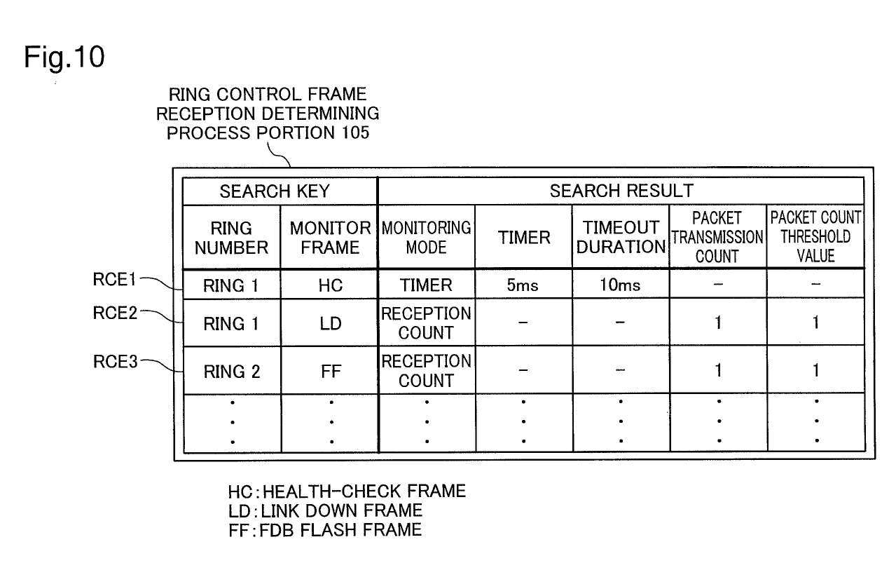

On the basis of the ring control frame monitoring table 103 (FIG. 10), the ring control frame reception determining portion 105 will monitor status of the rings R1, R2 with reference to the search keys of ring number and monitor frame. For example, when a health-check frame HC cannot received for a period of 10 milliseconds, it will be determined that a failure has occurred on ring R1 (record RCE1).

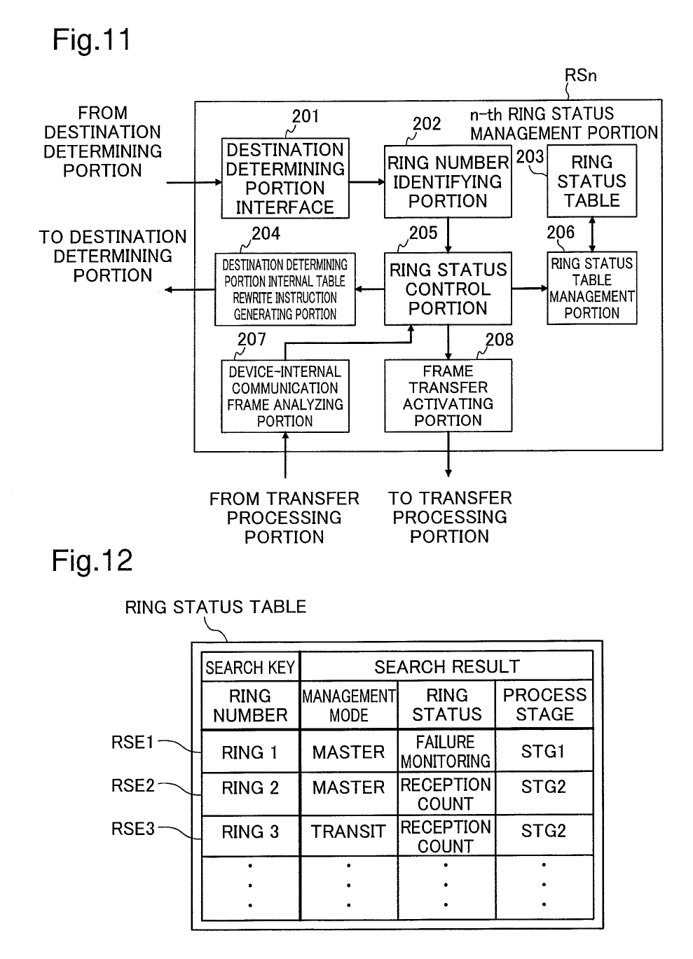

FIG. 11 is an illustration depicting the internal configuration of the n-th ring status management portion RSn of the embodiment. The first through n-th members of the n ring status management portions RS1 through RSn have identical internal configuration. The n-th ring status management portion RSn includes a destination determining portion interface 201 functioning as the interface with the n-th destination determining portion HDn; a ring number identifying portion 202 for identifying the ring number; a ring status table 203 (FIG. 12); a destination determining portion internal table rewrite instruction generating portion 204; a ring status control portion 205; a ring status table management portion 206; a device-internal communication frame analyzing portion 207; and a frame transfer activating portion 208.

The ring status table 203 manages the management mode, ring status, and process stage for each individual ring number. Management mode stores a flag indicating whether the n-th ring status management portion RSn is functioning as the master (lead) of each ring, or functioning as a transit (subordinate). Ring status stores a flag indicating failure monitoring status during normal operation, or recovery monitoring status when a failure has occurred. Process stage stores a flag indicating completion of rewriting of the logical circuit table STG1, completion of deletion of the MAC address table STG2, or completion of FDB flash transmission STG3. FDB flash refers to frame data for the purpose of clearing the MAC address (FDB) of a ring on which a failure has occurred, prior to rebuilding it.

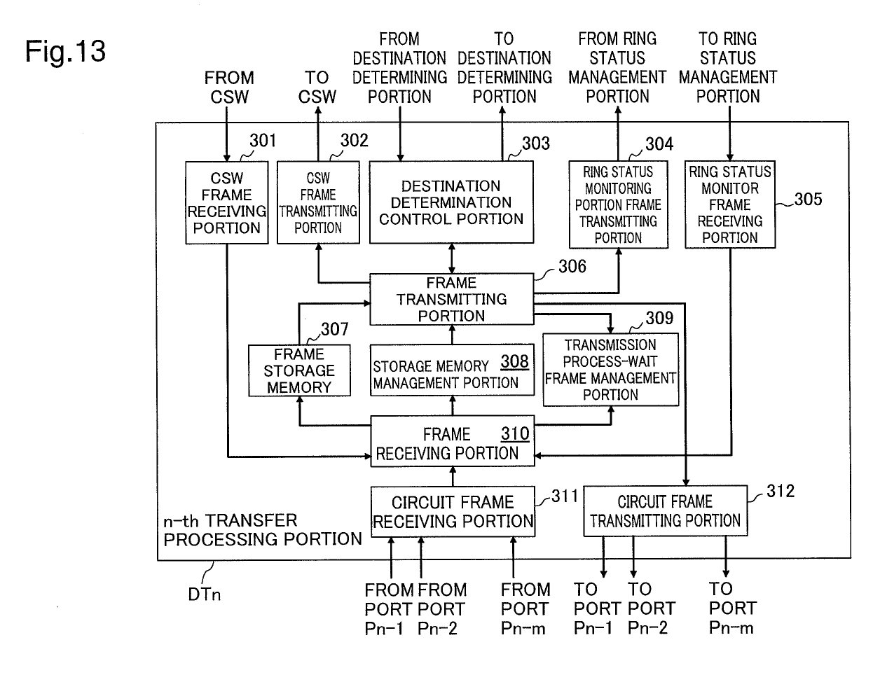

FIG. 13 is an illustration showing the internal configuration of the n-th transfer processing portion DTn of the present embodiment. The n-th transfer processing portion DTn includes a CSW frame receiving portion 301 for receiving frame data from the crossbar switch CSW; a CSW frame transmitting portion 302 for transmitting data to the crossbar switch CSW; a destination determination control portion 303 for handing off frame data to the n-th destination determining portion HDn and receiving from the n-th destination determining portion HDn information which represents the transfer destination; a ring status monitoring portion frame transmitting portion 304 for transmitting a control frame used to monitor ring status (e.g. a health-check frame HC) to the n-th ring status management portion RSn; and a ring status monitor frame receiving portion 305 for receiving ring status monitoring results from the n-th ring status management portion RSn.

The n-th transfer processing portion DTn further includes a frame receiving portion 310 for receiving frame data that was received from the input/output ports P1-1 through Pn-m via a circuit frame receiving portion 311; a frame storage memory 307 for temporary storage of the received frame data; a storage memory management portion 308 for managing the frame storage memory 307; a transmission process-wait frame management portion 309 for managing stored frame data until the transmission process; and a frame transmitting portion 306 for outputting frame data to the CSW frame transmitting portion 302, the destination determination control portion 303, the ring status monitoring portion frame transmitting portion 304, and the input/output ports P1-1 through Pn-m. Output to the input/output ports P1-1 through Pn-m takes place via a circuit frame transmitting portion 312.

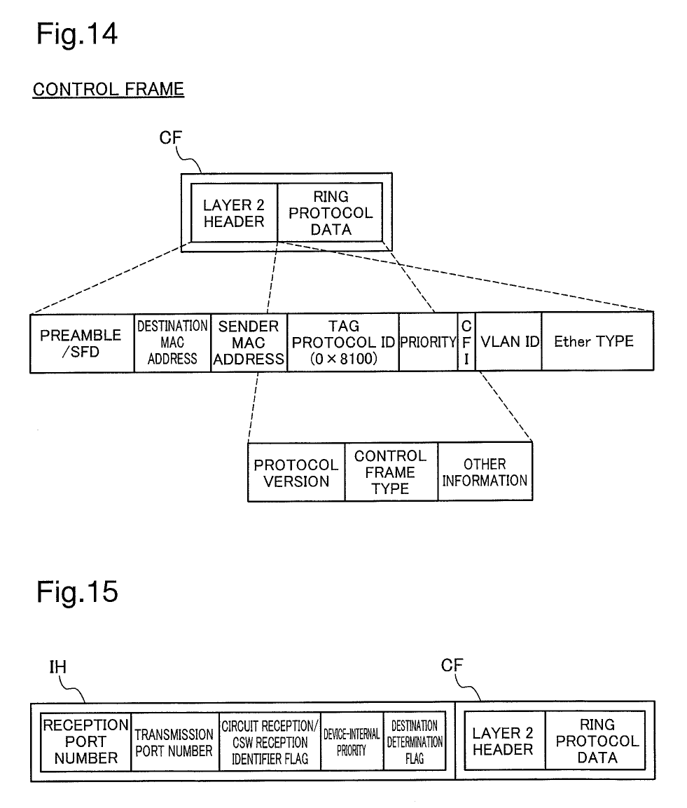

FIG. 14 is an illustration depicting the control frame format of a ring control frame CF in the embodiment. This control frame format is composed of a Layer 2 header and ring protocol data. The Layer 2 header format is identical to a Tag1 stage Ether header. In the control frame format, a value of 0x8100 indicating that a VLAN tag follows has been set for the Tag protocol ID.

The VLAN tag includes priority, a CF1, and a VLAN ID. A value by which the switch S1 of the present invention can be identified as the ring protocol has been set in the Ether type field. A value indicating high priority is stored in the priority field. This is because it is necessary for control frame CF transmission and reception by the other switches S2 through S7 to take place reliably even in the event of network convergence.

The ring protocol data stores protocol version which indicates the version of the ring protocol; control frame type; and other information. A value indicating a class of control frame is stored in the control frame type field. In this embodiment, frame classes corresponding to values are shown. The frame classes are: the health-check frame HC, an FDB flash frame FF, and a link down frame LD. In the “other information” it is possible to set other values needed for use in ring control.

FIG. 15 is an illustration depicting device-internal control frame format of a device-internal control frame in the embodiment. The device-internal control frame format is composed of frame data that includes an internal header IH appended to the ring control frame CF. In the internal header IH are stored a reception port number, a transmission port number, a circuit reception/CSW reception identifier flag, device-internal priority, and a destination determination flag.

In the reception port number field the number of the port that received the frame is stored as the setting during reception. In the transmission port number field is stored to the number of the transmission port determined subsequent to the destination determination process. Were the destination is the crossbar switch CSW, the transmission port number may be shown as bitmap information in consideration of the fact that there are multiple destination frame processing portions FP1 through FPn (FIG. 1). Meanwhile, the number of the port for transmitting a frame received from the crossbar switch CSW for transmission to switch S2 or another circuit will be stored.

In the circuit reception/CSW reception identifier flag field is stored a flag for distinguishing between an instance of reception from a circuit and an instance of reception from the crossbar switch CSW. This flag is used for process branching (searching different tables) by the destination determining portions HD1-HDn. The device-internal priority stores the processing priority in the transfer process portions DT1 through DTn during transmission to the crossbar switch CSW, and the processing priority in the transfer process portions during transmission to the switch S2 or other circuit. The device-internal priority will be determined on the basis of frame header information (destination MAC address, priority, Ether Type, or other information) during frame reception from the switch S2 or other circuit.

The destination determination flag is a flag which shows whether a destination for frame data has been determined. When the destination determination flag has been set, the destination determination control portion 303 (FIG. 13) will transfer frame data to the frame transmitting portion 306, without asking the n-th destination determining portion HDn (FIG. 5) for the transfer destination.

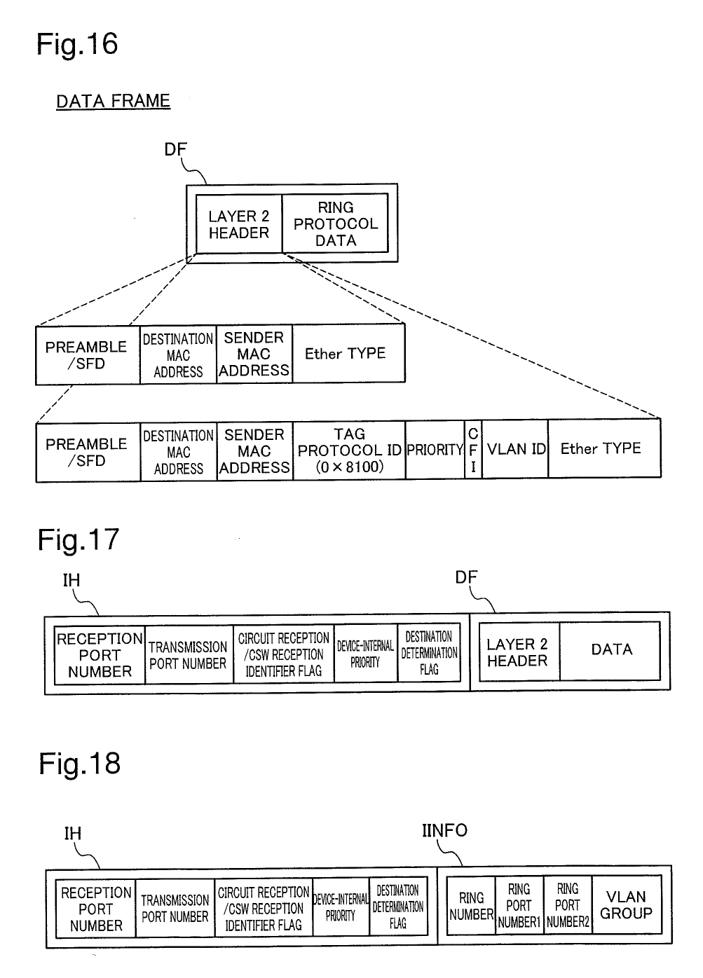

FIG. 16 is an illustration depicting the data frame format of a data frame DF in the embodiment. This data frame format is composed of a Layer 2 header and user data. The format of the Layer 2 header is similar to the control frame format, but does not always require that a value indicating high priority be stored in the priority field.

FIG. 17 is an illustration depicting device-internal data frame format of a device-internal data frame in the embodiment. The device-internal data frame format is composed of frame data that includes an internal header IH appended to a data frame DF. The format of the internal header IH is similar to the control frame format.

FIG. 18 is an illustration depicting the frame format of a device-internal ring status management portion intercommunication frame in the embodiment. This frame is a communication frame used for communication among the n first through n-th ring status management portions RS1 through RSn. The frame format of this frame is composed of frame data that includes an internal header IH appended to device-internal information INFO. The format of the internal header IH is similar to the control frame format.

This communication frame is a frame for the purpose making any of the ring status management portions RS1 through RSn execute “a process of FDB flash transmission,” “a process of logical circuit mode change (individual circuit+VLAN group management.” or “a process of MAC address table entry deletion (individual circuit+VLAN group deletion). This frame stores data which represents a “ring number,” “ring port number,” or “VLAN group” for executing such processes.

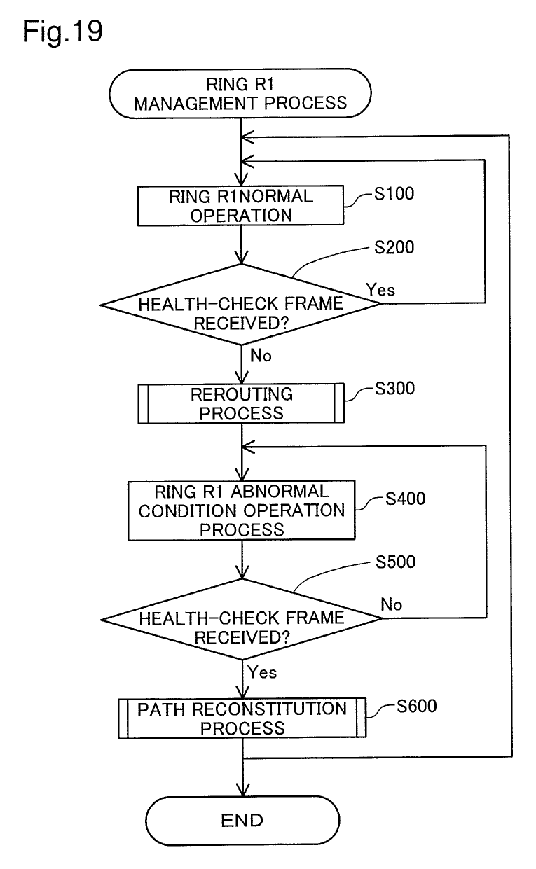

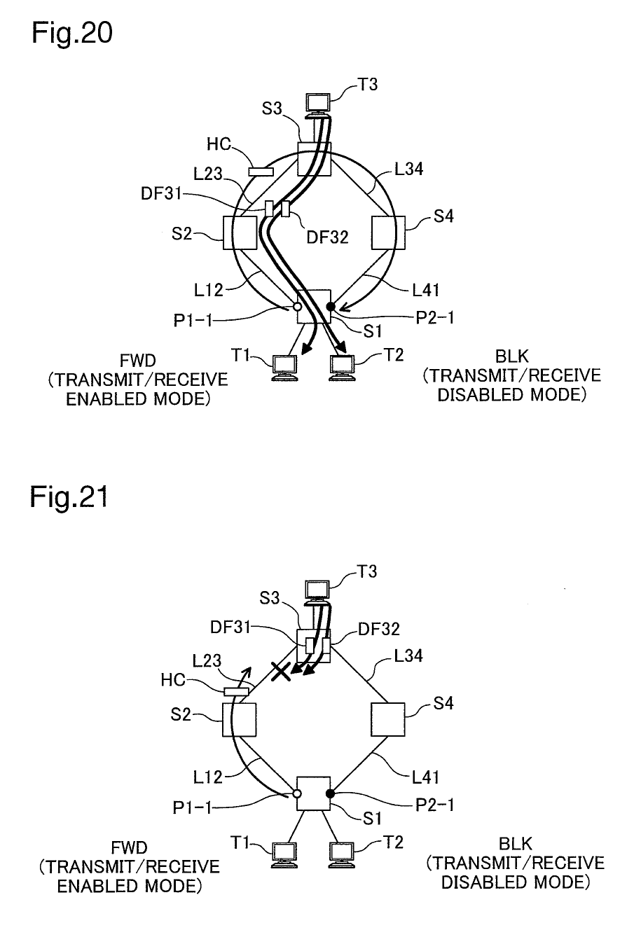

FIG. 19 is a flowchart depicting the process specifics of the Layer 2 ring protocol operation of the ring R1 (FIG. 1) in the embodiment of the present invention. FIG. 20 is an illustration depicting Layer 2 ring protocol operation of the ring R1 in the embodiment. The ring R1 is composed of four switches S1 through S4 and four circuits L12, L23, L34, L41. Among the four switches S1 through S4, the switch S1 has been designated as the master switch (or lead switch), and the other four switches S2 through S4 have been designated as transit switches (transit switches or subordinate switches).

In Step S100, the ring R1 is operating normally as shown in FIG. 20. The switch S1 uses for this ring the port P1-1 (FIG. 1) that functions as the primary port in a mode enabling sending/receiving of all frames inclusive of data frames (forwarding mode), and the port P2-1 that functions as the secondary port in a mode for receiving health-check HC and other control frames (FIG. 14) only, while blocking data frames (blocking mode). The purpose of blocking data frames in the secondary port is to prevent a broadcast stream from occurring.

Data transmission on the ring R1 is carried out in the following manner, taking the example of data transmission from the terminal T3 to the terminals T1 and T2. When a data frame DF31 (FIG. 20) is transmitted from the terminal T3, it will be transferred to the terminal T1 via the three switches S3, S2, and S1. Transfer of a data frame DF32 to the terminal T2 will also take place via the three switches S3, S2, S1. In this way, frame data received by any of the four switches S1 through S4 will be repeatedly transferred by the four switches S1 through S4 via the four circuits L12, L23, L34, L41 to reach the terminals T1, T2.

Meanwhile, in normal operation, failure monitoring of the ring R1 will be carried out during the Layer 2 ring protocol operation. Failure monitoring of the ring is carried out by periodic transmission of a health-check frame HC, which is one type of control frame, from the primary port P1-1 to the secondary port P2-1 by the switch S1 designated as the master switch while monitoring reception by the secondary port P2-1. As will be understood from FIG. 20, since the health-check frames HC are transferred from the primary port P1-1 to the secondary port P2-1 via all four of the switches S1 through S4 and the four circuits L12, L23, L34, L41, a failure of even a single element of the ring R1 means that the frames will not reach the secondary port P2-1.

FIG. 21 is an illustration depicting a state in which a failure has occurred on the circuit L23 in the ring R1. In this state, a communication failure has occurred between the switch S2 and the switch S3, and under these circumstances the data frames DF32, DF31 cannot reach the terminals T1, T2. Meanwhile, the periodically transmitted health-check frames HC will never reach the secondary port P2-1, thereby making it possible on the basis of failure of the health-check frame HC to arrive within the prescribed time (10 milliseconds in the embodiment) for the switch S1 to detect that a problem has occurred in any one of the elements of the ring R1.

In this way, normal operation of the ring R1 (Step S100) will continue as long as the health-check frames HC periodically arrive at the secondary port P2-1; whereas if a problem is detected through failure of the health-check frames HC to arrive within the prescribed time, the process will advance to Step S300 (Step S200).

In Step S300, the switch S1 executes a rerouting process. The rerouting process refers to a process for building a new path that avoids the failure site. Wrapping, which involves repeated wrapping in proximity to the failure site, and steering, which involves switching to a ring that does not pass through the failure site, are types of ring protocol rerouting. In the embodiment, rerouting is accomplished through steering.

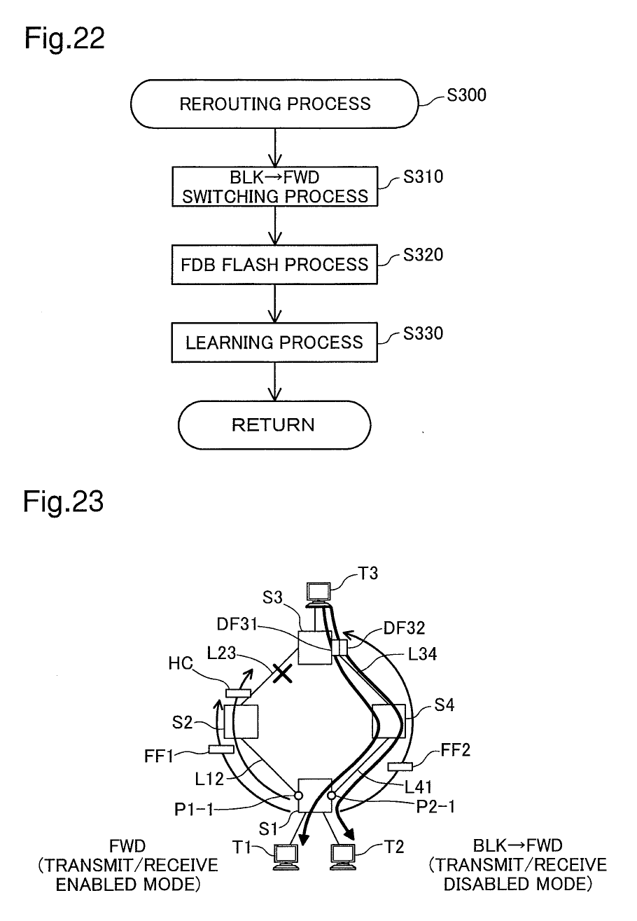

FIG. 22 is a flowchart depicting the specifics of the rerouting process of the embodiment. FIG. 23 is an illustration depicting rerouting in the event that a failure has occurred in the circuit L23 in the ring R1. In Step S310, the switch S1 transitions the logical circuit mode setting of the secondary port P2-1 (FIG. 1) from “blocking mode BLK” to “forwarding mode FWD” so that data frames can be received by the secondary port P2-1. During this time, since the failure has occurred in the circuit L23, the ring R1 will not constitute a loop, and a broadcast stream will not occur.

In Step S320, the switch S1 executes an FDB flash process. The FDB flash process refers to a process of clearing the MAC address table 102 of all devices connected to the ring R1, as well as transmitting an FDB flash frame FF to all switches S2 through S4 of the ring R1. By so doing, the MAC addresses are cleared in all switches S2 through S4 of the ring R1, producing a flooding condition. A flooding condition refers to a condition in which nodes transmit data received by input ports to all output ports.

In Step 330, the switch S1 executes a learning process. In the flooding condition, the data frames DF32, DF31 will reach the switch S1 via the switches S3, S4, and arrive at the terminals T1, T2. During this time, the switches S1, S3, S4 will learn the route which passes through the switch S1, the switch S3, and the switch S4. This constitutes the learning process. When this learning process is complete, the flooding condition will terminate returning communication status to normal capability, and the process will return to Step S400 (FIG. 19).

In Step S400, the switch S1 executes an abnormal condition operation process. The abnormal condition operation process refers to a process whereby, in the presence of continuing communication status which avoids the problem site, transmission of health-check frames HC from the primary port P1-1 to the secondary port P2-1 of the switch S1 will continue in anticipation of recovery by the circuit L23. Since an additional problem occurring with an element of the ring R1 would result in an area of disabled communication, the abnormal condition operation process will represent nothing more than a temporary communication status until the circuit L23 recovers. The abnormal condition operation process produces a loop in the ring R1 upon recovery by the circuit L23, and thus a broadcast stream may occur in some circumstances.

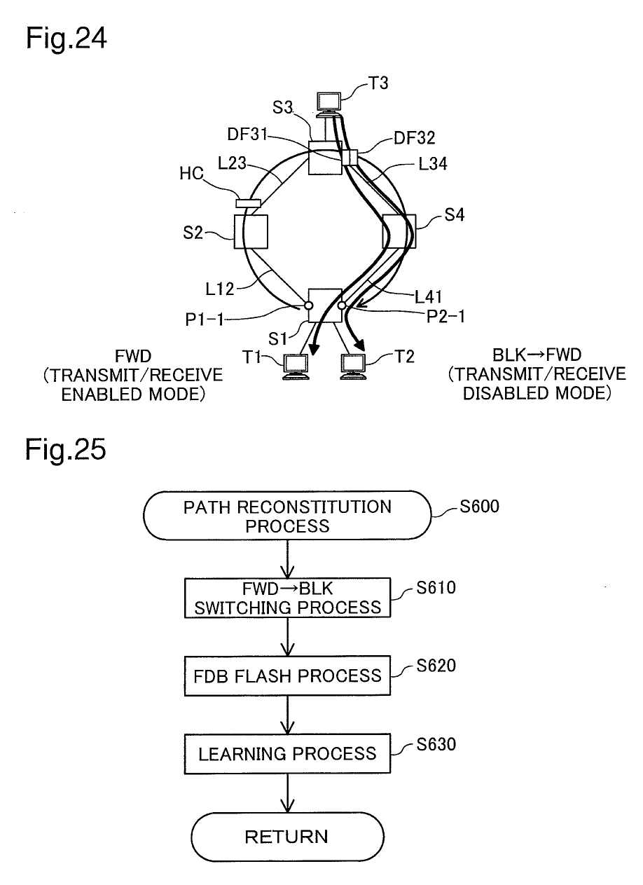

FIG. 24 is an illustration of a condition immediately after recovery by the circuit L23 in the ring R1. Once the circuit L23 has recovered, the secondary port P2-1 will receive a health-check frame HC. Reception of the health-check frame HC by the secondary port P2-1 indicates that all four of the switches S1 through S4 and all four of the circuits L12, L23, L34, L41 are normal, and thus it will be ascertained that it is possible to return the ring R1 to normal operation. Meanwhile, in this condition, a broadcast stream may occur in some circumstances as mentioned above.

In this way, the ring R1 abnormal condition operation process (Step S400) will continue for as long as a condition in which health-check frames HC fail to arrive at the secondary port P2-1 persists; on the other hand, once recovery of the circuit L23 has been detected through arrival of a health-check frame HC at the secondary port P2-1, the process will advance to Step S600 (Step S500).

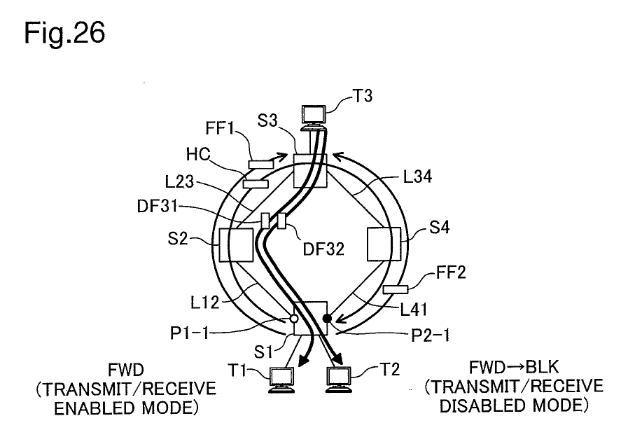

FIG. 25 is a flowchart depicting the specifics of a path reconstitution process of the embodiment. FIG. 26 is an illustration depicting transition of operation of the ring R1 to a normal condition. In Step S610, the switch S1 restores the logical circuit mode setting of the secondary port P2-1 from “forwarding mode FWD” to “blocking mode BLK” so that the secondary port P2-1 can no longer receive data frames. By so doing, the occurrence of a broadcast stream can be prevented.

In Step S620, the switch S1 executes an FDB flash process. This clears the MAC addresses in all switches S1 through S4 of the ring R1 in the same manner as in Step S320, thus producing a flooding condition.

In Step S630, the switch S1 executes a learning process. In the flooding condition, the data frames DF32, DF31 will reach the switch S1 via the switches S3, S42, and arrive at the terminals T1, T2. During this time, the switches S1, S2, S3 will learn the route which passes through the switch S1, the switch S2, and the switch S3. When this learning process is complete, the flooding condition will terminate returning communication status to normal capability, and the process will return to Step S100 (FIG. 19).

This sort of ring protocol operation process is executable in any of the n first through n-th ring status management portions RS1 through RSn which are interconnected via the crossbar switch CSW in the above manner and controlled concertedly by the device managing portion 300. Such a configuration allows for flexible distribution of the burden of managing multiple rings under management by the switch S1, thus making it possible to flexibly accommodate an increase or decrease in the number of accommodated rings or faster process speeds, simply by increasing or decreasing the number of frame processing portions FP1 through FPn, for example, so that scalability can be assured.

In the preceding embodiment, the health-check frames HC are transmitted in a single direction, but an arrangement involving bidirectional transmission in the opposite direction as well is also acceptable.

B. Modifications:

While the present invention has been shown hereinabove based on certain preferred embodiments, the invention is in no wise limited to the particular embodiments herein and various modifications such as the following can be made herein without departing from the scope of the invention.

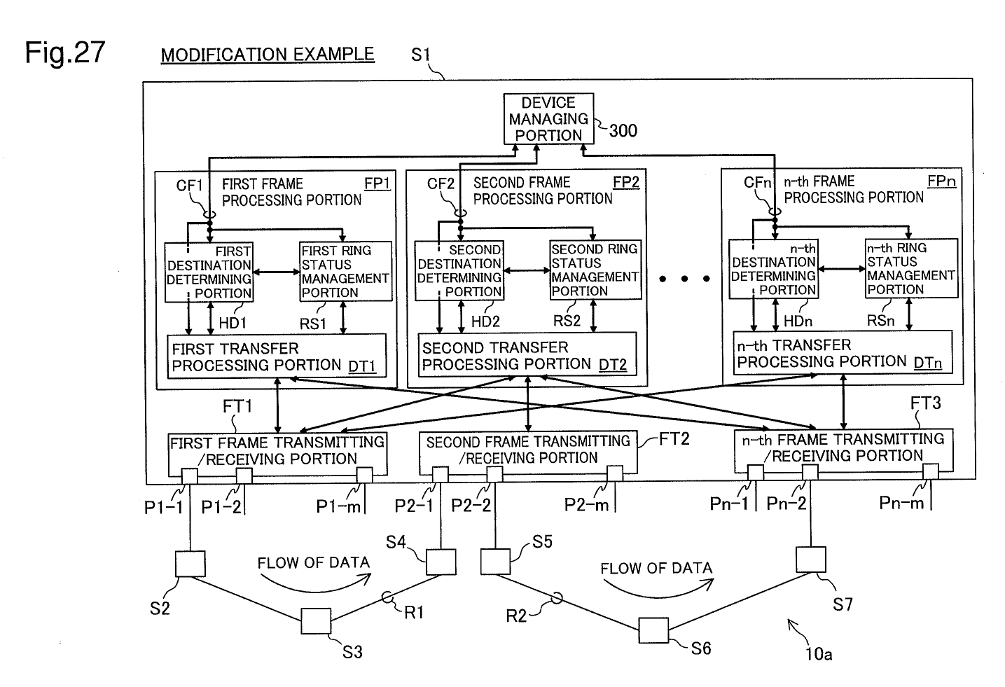

B-1. In the preceding embodiments, the n first through n-th frame processing portions FP1 through FPn are interconnected via the crossbar switch CSW, but a configuration in which the n first through n-th frame processing portions FP1 through FPn are connectable with the n first through n-th frame transmitting/receiving portions FT1-FTn in any combination as depicted in FIG. 27 for example would be acceptable as well.

B-2. In the preceding embodiments, the configuration enables any frame processing portion among the n first through n-th frame processing portions FP1 through FPn to manage any ring, but it is not necessary that any ring be manageable by any of the n first through n-th frame processing portions FP1 through FPn. In the present invention, it is acceptable to have a configuration whereby connections among at least some of a plurality of ring networks and at least some of a plurality of transfer resources are modifiable; as well as a configuration whereby a transfer resource selected from least some of a plurality of the transfer resources is controlled so as to enable management of at least some of a plurality of ring networks.

What is claimed is:

1. A data transfer device comprising:
a number n (where n is an integer equal to 2 or greater) of transfer resources that function as nodes of a number m (where m is an integer equal to 2 or greater) of ring networks;
a number p (where p is an integer equal to 2 or greater) of ring management resources that manage at least some of the n transfer resources so as to function as master nodes of the ring networks;
connection lines that interconnect the p ring management resources and the n transfer resources; and
a controller portion that controls the ring management resources and the connection lines, and switches the ring management resources which manage at least some of the n transfer resources.

2. The data transfer device according to claim 1, further comprising a plurality of frame processing portions that have the transfer resources and the ring management resources.

3. The data transfer device according to claim 2,
wherein the controller portion specifies, in accordance with user input, any of the plurality of frame processing portions functioning as respective nodes for the m ring networks; and specifies, in accordance with user input, a frame processing portion that will be switched to from the specified frame processing portion in the event that a failure occurs in the specified frame processing portion.

4. The data transfer device according to claim 2, wherein
the frame processing portion further includes a destination determining portion that determines the transfer destination of the transfer resources; and
the destination determining portion determines a destination such that a health-check frame received by the data transfer device is returned to the ring management resources within the data transfer device.

5. The data transfer device according to claim 1, wherein
at least some of the p ring management resources and the n transfer resources are interconnected by a crossbar switch; and
switching of the crossbar switch is executed as the control of connection lines.

6. The data transfer device according to claim 5, wherein
the controller portion controls the ring management resources and the connection lines, and via the ring network under management by the ring management resources, returns to the ring management resource a health-check frame that was sent from the ring management resources.

7. A data transfer method comprising the steps of:
providing a number n (where n is an integer equal to 2 or greater) of transfer resources functioning as nodes of a number m (where m is an integer equal to 2 or greater) of ring networks, a number p (where p is an integer equal to 2 or greater) of ring management resources for managing at least some of the n transfer resources so as to function as master nodes of the ring networks, and connection lines interconnecting the p ring management resources and the n transfer resources; and
controlling the ring management resources and the connection lines, and switching the ring management resources which manage at least some of the n transfer resources.
